(19) United States
(12) Patent Application Publication
(10) Pub. No.: US 2025/0286760 A1
(43) Pub. Date: Sep. 11, 2025

(54) PHASE-MULTIPLEXED QUADRATURE RECEIVER

(71) Applicant: The Regents of the University of California, Oakland, CA (US)

(72) Inventors: James Buckwalter, Santa Barbara, CA (US); Justin Kim, Santa Barbara, CA (US)

(21) Appl. No.: 19/070,181

(22) Filed: Mar. 4, 2025

Related U.S. Application Data
(60) Provisional application No. 63/562,813, filed on Mar. 8, 2024.

(51) Int. Cl. H04L 27/22

(52) U.S. Cl. CPC H04L 27/22

(57) ABSTRACT

A phase-multiplexed quadrature receiver includes an RF signal interface providing an RF signal to a mixer. The receiver includes a local oscillator and a phase shifter that multiplexes phase states of the local oscillator applied to the mixer between at least four I/Q phases within each symbol period of the RF signal to produce a complex radio-frequency waveform. A synchronized set of baseband switches that sample voltage from the mixer across at least two capacitors to demodulate the complex radio-frequency waveform into in-phase and quadrature components.

### PRIORITY CLAIM AND REFERENCE TO RELATED APPLICATION

The application claims priority under 35 U.S.C. § 119 and all applicable statutes and treaties from prior U.S. provisional application Ser. No. 63/562,813, which was filed Mar. 8, 2024.

### FEDERALLY SPONSORED RESEARCH AND DEVELOPMENT

This invention was made with government support under grant no. 2215646 awarded by the National Science Foundation. The government has certain rights in the invention.

### FIELD

Fields of the invention include signal reception and receivers. The invention concerns a quadrature receiver.

### BACKGROUND

All modern radios in cellphones, satellite terminals, and base stations require an I/Q (quadrature) receiver to demodulate complex digital signals such as QPSK (Quadrature Phase Shift Keying) and QAM (Quadrature Amplitude Modulation). FIGS. 1A and 1B show the current types of circuits used as quadrature receivers. FIG. 1A is the block diagram of a state-of-the-art homodyne/direct conversion quadrature receiver. FIG. 1B is the block diagram of a state-of-the-art heterodyne conversion quadrature receiver. These heterodyne receiver of FIG. 1B is an extension of the homodyne receiver of FIG. 1B that moves the first mixing product to an intermediate frequency.

Each of the FIGS. 1A and 1B quadrature receivers requires a pair of I/Q mixers to separately downconvert the I and Q phases of an LO (local oscillator), shown as being frequency multiplied by a factor M, and split through a quadrature phase shifter that creates a static 0- and 90-degree phase shift. FIGS. 1C and 1D show that an I/Q imbalance degrades ability of these circuits to demodulate digital signals. Generally, these circuits are sensitive to LO feedthrough, DC offset, gain/amplitude mismatch and power consumption considerations due to the need to drive two separate mixers and their separate signal paths and ADC converters.

### SUMMARY

A phase-multiplexed quadrature receiver according to an embodiment of the invention includes an RF signal interface providing an RF signal to a mixer. The receiver includes a local oscillator and a phase shifter that multiplexes phase states of the local oscillator applied to the mixer between at least four I/Q phases within each symbol period of the RF signal to produce a complex radio-frequency waveform. A synchronized set of baseband switches sample voltage from mixer across at least two capacitors to demodulate the complex radio-frequency waveform into in-phase and quadrature components.

### BRIEF DESCRIPTION OF THE DRAWINGS

FIGS. 1A and 1B (Prior Art) are block diagrams of respective homodyne and heterodyne quadrature receivers. Homodyne receivers convert the incoming RF signal to a baseband (BB) I and Q sampling receiver. Heterodyne receivers use an intermediate frequency (IF) to convert the RF signal for improved filtering of the signal.

FIGS. 1C and 1D (Prior Art) are IQ constellation plots that show the possible receiver I/Q imbalance that results in the receivers shown in FIGS. 1A and 1B.

FIG. 1C indicates the impact of amplitude imbalance between the I path and Q path in the receivers degrades ability of these circuits to demodulate digital signals.

FIG. 1D indicates the phase imbalance between the I and Q path due to the poor precision of the quadrature coupler in the local oscillator (LO) path. In wideband systems, I/Q amplitude and phase imbalance becomes particularly problematic.

FIG. 2A is a block diagram of a phase-multiplexed quadrature receiver according to a preferred embodiment,

FIG. 2B a timing diagram for the phase shifter of the FIG. 2A phase-multiplexed quadrature receiver.

FIG. 2C is control logic for the phase shifter of the FIGS. 2A phase-multiplexed quadrature receiver.

FIGS. 3A-3D illustrate the four phase states, phase 0, phase 1, phase 2 and phase 3, of the FIG. 2 phase-multiplexed quadrature receiver.

FIG. 4 is a block diagram with an IQ plot and signal explaining how the FIG. 2 phase-multiplexed quadrature receiver conducts quadrature demodulation.

FIG. 5 shows signals at different parts of the FIG. 2 phase-multiplexed quadrature receiver during I/Q demodulation.

FIGS. 6A and 6B-6C respectfully show a circuit diagram and an example fabricated circuit of a preferred high-speed phase shifter for the FIG. 2 quadrature receiver.

FIG. 6D is a block diagram of a preferred digital circuit to control the phase states of the FIGS. 6A-6B phase shifter.

FIG. 7 shows S-parameters of the FIGS. 6A-6B phase shifter.

FIG. 8 shows the relative phase states of the FIGS. 6A-6B phase shifter.

FIG. 9 shows an example of the digital phase control signals of the FIGS. 6A-6B phase shifter.

FIG. 10A is a block diagram of a phase-multiplexed quadrature receiver according to a preferred embodiment.

FIG. 10B a timing diagram for the phase shifter of the FIG. 10A phase-multiplexed quadrature receiver.

FIG. 10C is control logic for the phase shifter of the FIGS. 10A phase-multiplexed quadrature receiver.

### DETAILED DESCRIPTION OF THE PREFERRED EMBODIMENTS

Preferred embodiment quadrature receivers improve the state of the art and avoid problems associated with having multiple mixers on separate paths. A preferred receiver includes a fast, low-resolution phase-shifter that multiplexes the phase state of a local oscillator that is exposed to a radio-frequency mixer. Preferred quadrature receivers include a single I/Q mixer that mixes all phase states of the received signal.

A preferred phase-multiplexed quadrature receiver has a low-resolution, e.g. 2-bit, phase shifter that rapidly switches between 4 discrete phase states that represent 0, 90, 180, and 270-degree phases to multiplex the phase state of the local oscillator exposed to a radio-frequency mixer. Simultaneously, a synchronized set of baseband switches samples the voltage from the mixer across two capacitors to demodulate the complex radio-frequency waveform into in-phase and quadrature components. The synchronization of phase states in the local oscillator path with baseband switch states permits a single mixer to demodulate a complex signal.

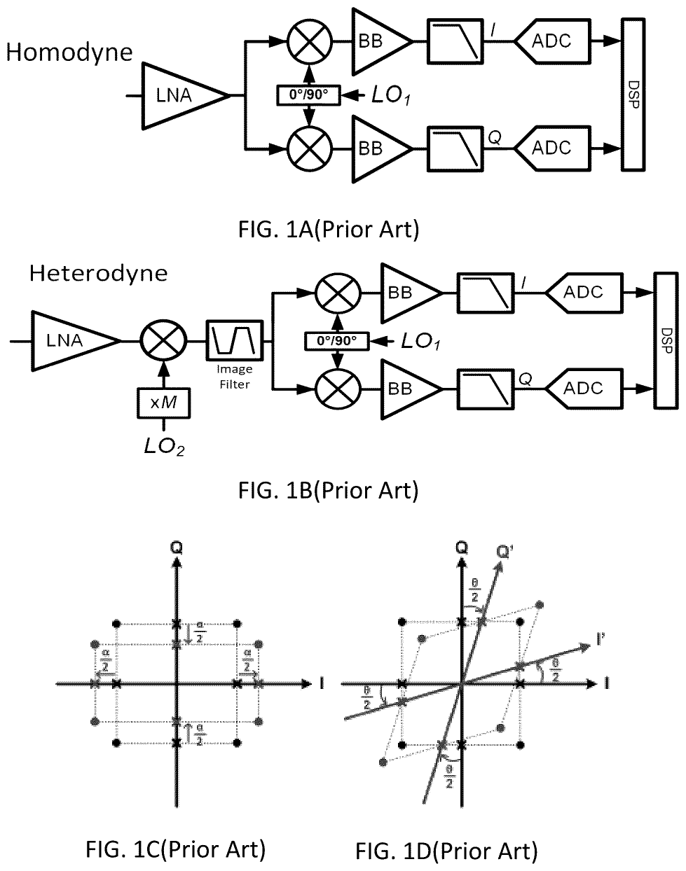

Preferred embodiments have several advantages. Preferred phase-multiplexed quadrature receivers require only a single I/Q mixer while achieving all the same functionality of the conventional dual I/Q mixer/dual path arrangement to demodulate a complex signal. The single I/Q mixer and single path reduce the area required for the receiver and, also reduce power consumption required for generating a local oscillator compared to the conventional receivers of FIGS. 1A and 1B. Preferred phase-multiplexed quadrature receivers eliminate gain, phase, and DC offsets that hampers the operation of the FIGS. 1A and 1B conventional I/Q receivers since there is a single signal path. The offsets in the conventional dual mixer arrangements require digital calibration and correction, adding power consumption and complexity. Additionally, LO feedthrough is eliminated since each signal phase is exposed alternately to both sides of the capacitor. Preferred phase-multiplexed quadrature receivers provide inherent filtering through the baseband switched capacitor. Preferred phase-multiplexed quadrature receivers permit phases used to sample the incoming RF signal to be scrambled and re-sequenced to achieve other filtering and cancellation functions.

Preferred embodiments of the invention will now be discussed with respect to experiments and drawings. Broader aspects of the invention will be understood by artisans in view of the general knowledge in the art and the description of the experiments that follows.

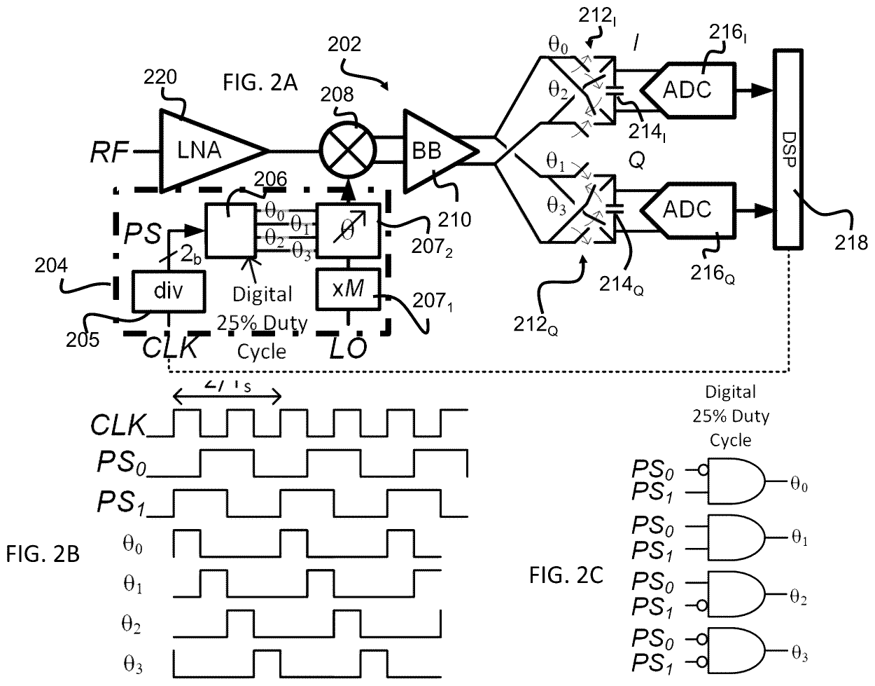

FIG. 2A shows a preferred embodiment phase-multiplexed quadrature receiver 202, FIG. 2B a timing diagram for its phase shifter 204, and FIG. 2C control logic for the phase shifter 204. The phase shifter 204 creates a phase shift signal (PS) that switches a local oscillator (LO) signal at a faster rate than the symbol period of the incoming RF signal. A divider module 205 provides a divided clock signal to generate sequential 25% duty cycle phase selection signals. Modules 205 and 206 can be realized via digital signals used to select one of the phases. In the example in FIG. 2A, the phases are selected in order (0, 90 180, 270) but the phases can also scramble and can be more than four phases. The example phase shifter 204 also includes a frequency multiplier 2071 that converts the LO frequency to the Mth harmonic, and is followed by the LO phase shifter 2072. The CLK signal can be generalized to the 2-bit control digital lines output by the clock divider 205. If more than four phases are used, the clock divider 205 can provide more bits, i.e., the necessary number of bits to encode the number of phases, e.g., 3 bits for eight phases, 4 bits for 16 phases, etc.

The CLK signal is determined by an estimate of the symbol period of the RF signal that the receiver 202 seeks to capture. The symbol period is estimated to enable switching between the clock phases. In the case of communication signals or radar signals, the symbol period can be known a priori used. A digital signal processor (DSP) can provide symbol period information, i.e., the DSP 218 guides the clock generation

At least four 25% duty cycle phase states should occur within the symbol period and are generated by a digital 25% clock generator 206. The symbol period is set by a CLK signal and is known a priori and set with a frequency synthesizer or is tracked through a data recovery circuit and provided to the digital divide by 4. Clock and data recovery circuits are commonly used in communication systems to recover a clock frequency by sensing the incoming signal and aligning the data edges to the clock edges, and such circuits are common data circuits use to track the CLK. The receiver 202 includes a single I/Q mixer 208 and can be configured to conduct either homodyne or heterodyne down-conversion. Subsequent to the I/Q. mixer 208 is a single baseband amplifier 210 that amplifies the baseband signal. Baseband switches 212, and 212Q are switched at the same rate as the LO phase shifter 204 to bin the down-converted information into +/− I and the +/− Q capacitors 214, and 214Q. Precise alignment of the phase shift signals and the baseband switches 212, and 212Q impacts the receiver sensitivity. The information binned into the capacitors 214, and 214Q are converted into digital signals by ADC converters 216, and 216Q and then processed by a digital signal processor 218. The DSP 218 extracts the data signal carried by a received RF signal that is first amplified by a low-noise amplifier 220 that provides the amplified RF signal to the I/Q mixer 208. The DSP 218 extracts the digital signal demodulated on the I and Q receive paths to reconstruct the transmitted information or to recover radar signals.

The phase-multiplexed quadrature receiver 202 can multiplex more phases for improved signal filtering and dynamic range. The signal can be multiplexed with 4N phases where N=2 would correspond with 8 phases each separated by 45 degrees and active for 12.5% duty cycle. The number of phases does not relate to the number of bits mapped on each signal. For example, a receiver of the invention can be constructed with N=1 for the phase shifter to decode either QPSK or 64 QAM, i.e 4, the receiver 202 can map both QPSK or 64 QAM. For 4N phases, 2N capacitors are required with 4N baseband switches and 2N ADCs to resolve the I and Q components with respect to the I/Q plane for decoding by the digital signal processor 218. This increases power consumption but improves signal filtering and dynamic range.

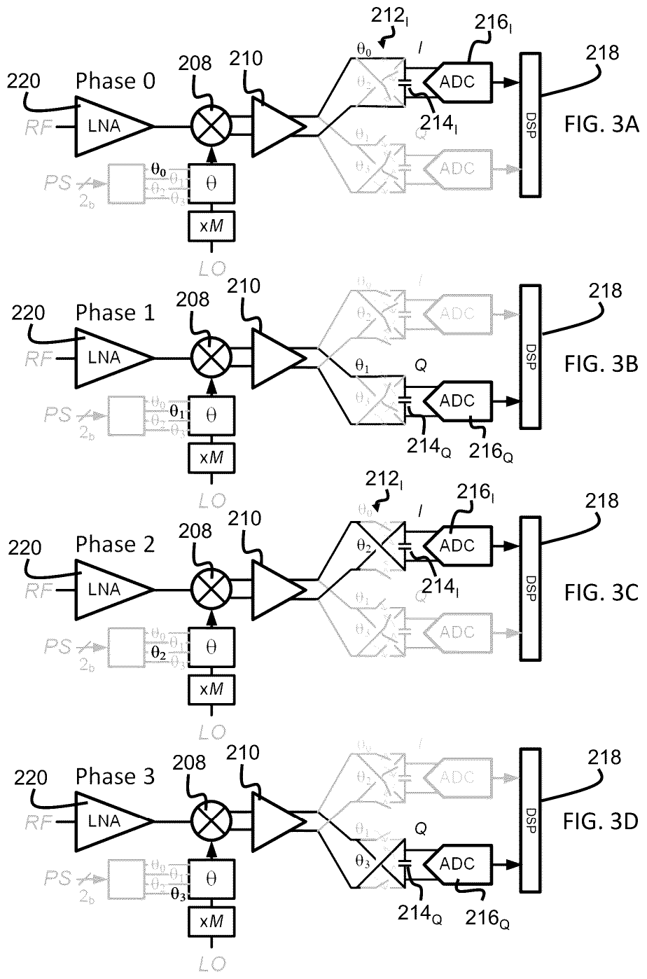

FIGS. 3A-3D illustrate the four phase states for QPSK encoding, phase 0, phase 1, phase 2 and phase 3, with the active signal decoding paths the phase-multiplexed quadrature receiver 202. The four phases correspond to shifting the LO with phase shifts of 0, 90, 180, and 280 degrees. Phase 0 and Phase 2 are related by 180-degree phase shifts and the signal is sampled in the I (in-phase) path during this period. The switches 212, alternate polarity across the capacitor 214, during phases 0 and 2. Phases 1 and 3 sample the signal on the Q (quadrature) path, with switches 212Q alternate polarity across the capacitor 214Q during phases 1 and 3.

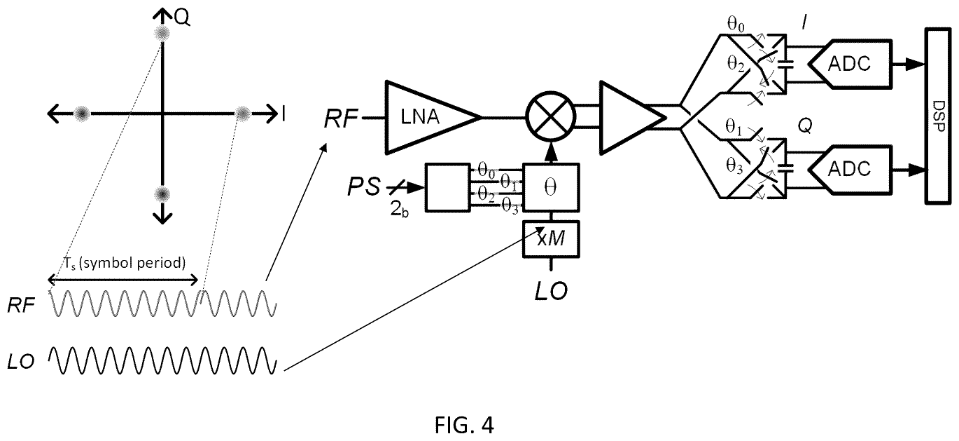

FIG. 4 illustrates how of the phase-multiplexed quadrature receiver 202 conducts quadrature demodulation. To demodulate a symbol period of Ts (which can have amplitude and phase components), the receiver 202 cycles through each of the phase shift states (0, 90, 180, 270) within the symbol period. The phase multiplexing includes at least 4 phases to demodulate a quadrature-amplitude modulation signal but can be a larger number of sampling phases.

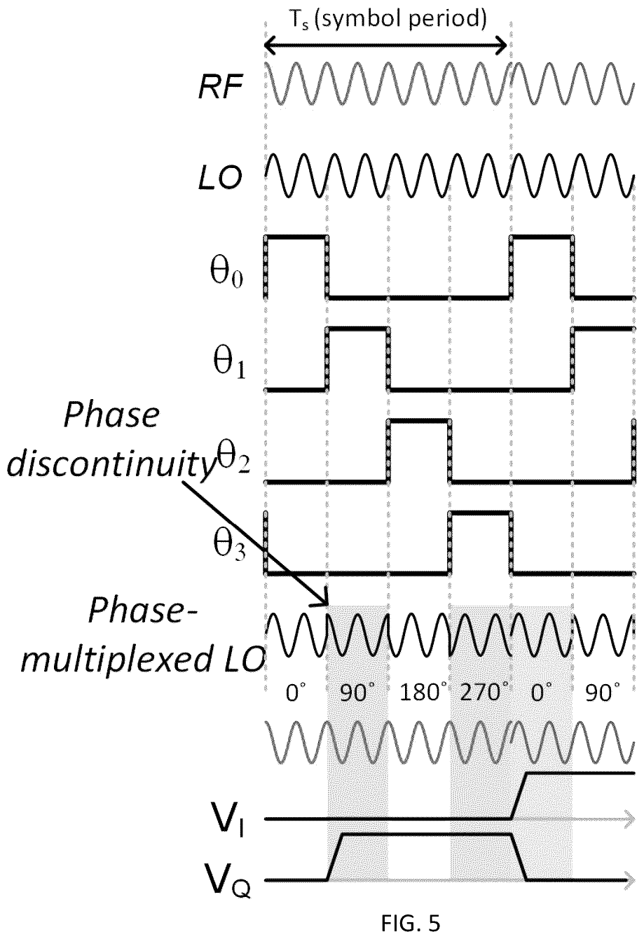

FIG. 5 shows signals of the phase-multiplexed quadrature receiver 202 during I/Q demodulation. The RF complex waveform can be changed in amplitude and phase over a period of Ts. The precise number of RF/LO cycles that occur within a period of Ts is not required to be known. However, within Ts, each of the 4 phase states should be sampled. The phase multiplexed LO has phase discontinuities that occur at the change in the phase state. The I signal is sampled on 0 and 180 degree phases and the Q signal is sampled on 90 and 270 degree phases. Mixing the phase multiplexed signal with the RF signal shows that the voltage on the I and Q capacitors properly demodulates the Q signal onto the Q capacitor and the I signal onto the I capacitor.

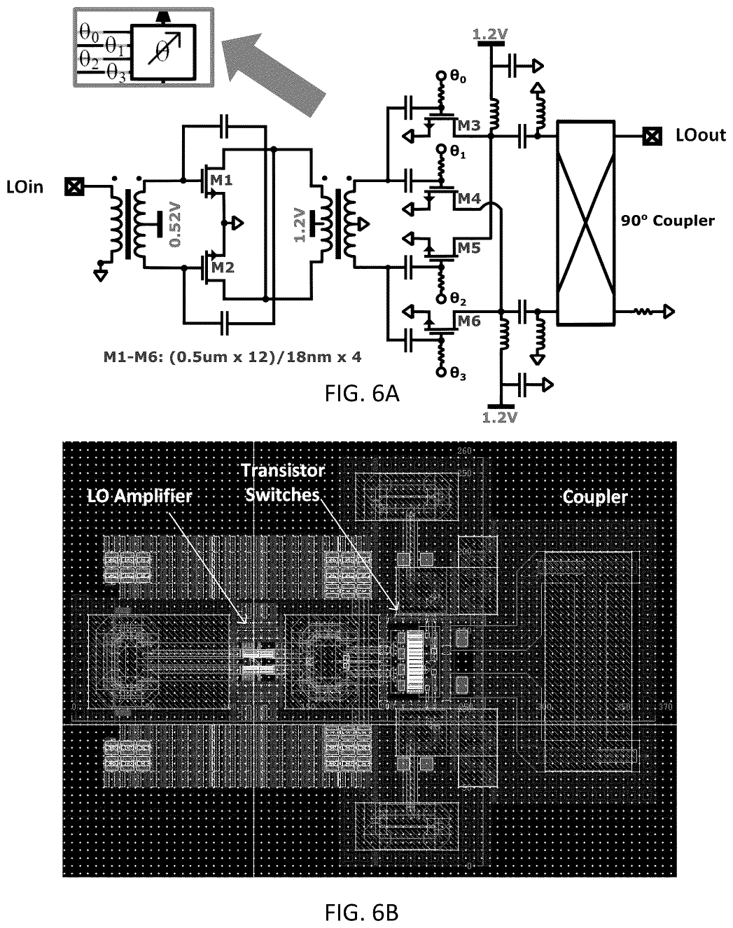

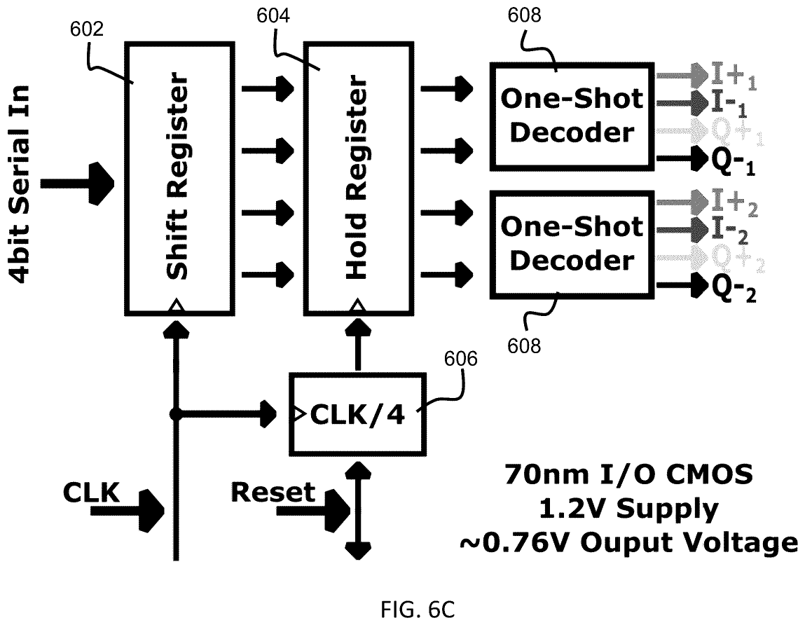

FIGS. 6A and 6B-6C respectfully show the circuit diagram and an example fabricated circuit of a preferred high-speed phase shifter for of the phase-multiplexed quadrature receiver 202. As seen in FIG. 6ne of the 4 phase states is digitally selected with the circuit that requires small area and low power consumption. M3-M6 are digitally controlled by the same digital code controlling the baseband capacitors (see FIGS. 2B and 2C). The preferred FIG. 6A phase shifter is activated (turning on) one of the control lines, e.g., Θ₁₋₄, the LO input is phase shifted between 0, 90, 180, and 270 degrees rapidly. The FIG. 6A circuit is very fast at changing the phase and is modulated faster than the symbol rate T of the RF signal.

As seen in FIG. 6C, A 90-degree phase shift is realized through a wideband passive circuit such as a coupler. A 180-degree phase shift is realized through a differential circuit produced with a transformer or balun. The layout of the phase shifter is illustrated in FIG. 6B to indicate the relative size of the phase shifter. FIG. 6C is a more sophisticated version of the shift register 204.

FIG. 6D shows a preferred digital circuit to control the phase states of the FIGS. 6A-6B phase shifter. In FIG. 6D, a shift register 602 receives serial bits produced by the DSP 218 (In one scheme, highlighted in FIG. 2A, the clock is used to go through a period series of clock sequences. This causes the phase to rotate from 0, 90, 180, and 270. In a more general approach, the phase states can be randomly sequenced by using a serial bit sequence would be generated by the DSP 218. The shift register 602 also receives the CLK signal. The CLK signal can be used in FIG. 6C to align in time the serial bits that are used to select the phases. The bits are output in parallel to a hold register 604. The hold register 604 is clocked by a divided version of the CLK, with the division corresponding to the number of bits, i.e., four serial bits requires a divide/4 clock module 606. One shot decoders 608, 610 ensure only one of the 4 lines is active at a time, preventing bit signals from activating more than one output at once. FIGS. 6A is an embodiment of a phase shifter where each of the phase selection signals activates a different path through the phase shifter.

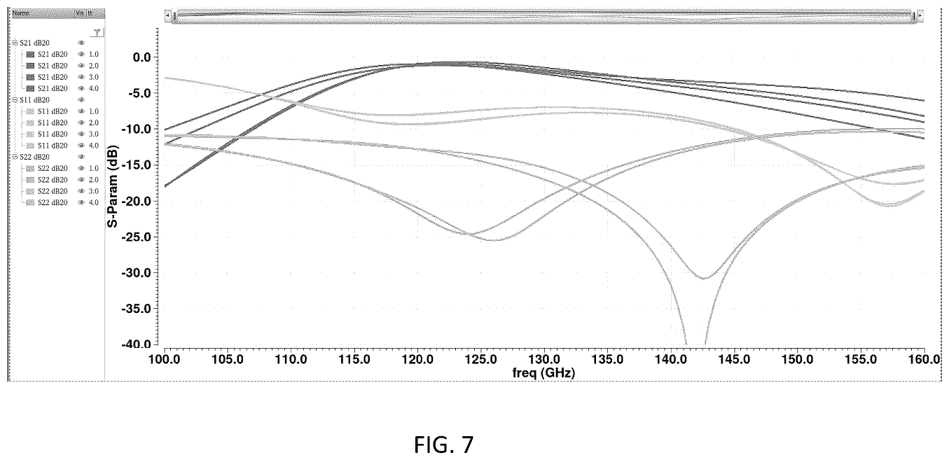

FIG. 7 shows the S-parameters of the FIGS. 6A-6B phase shifter. The four different phase states have similar S-parameters which represent the gain of the circuit and indicate that the phase shifter can be broadband and operate over a large fraction bandwidth.

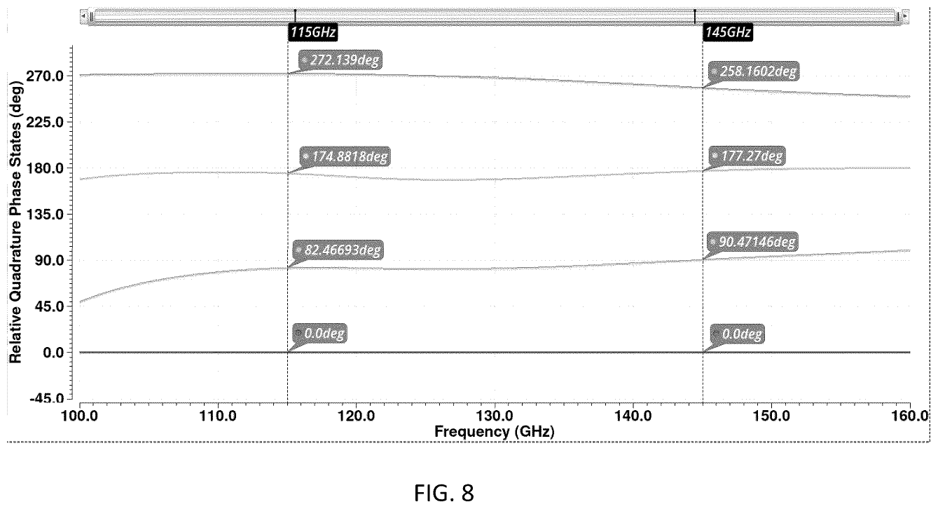

FIG. 8 shows the relative phase states of the FIGS. 6A-6B phase shifter. As seen in FIG. 8, each phase state is separated by approximately 90 degrees over a larger fractional bandwidth. The architecture can therefore operate over a large tuning range.

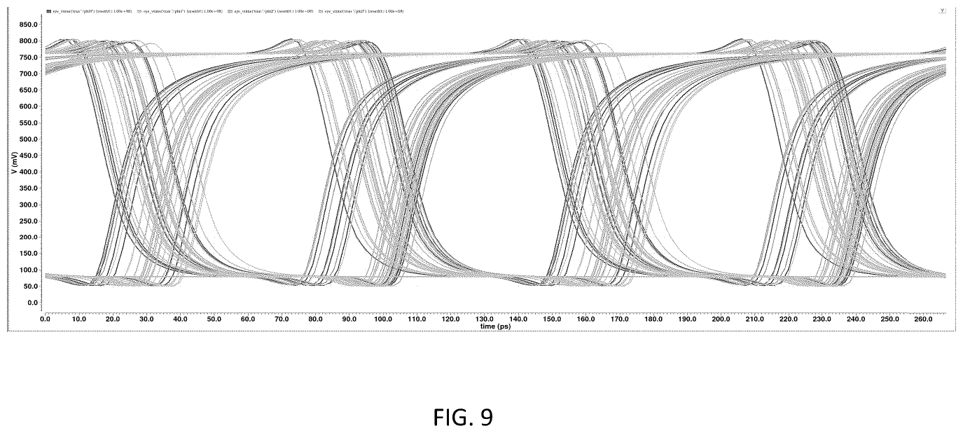

FIG. 9 shows an example of the digital phase control signals of the FIGS. 6A-6B phase shifter. The four phase states are shown with operating a clock signal of 15 GHZ. As seen in FIG. 9, each of the 4 signals has roughly 25% duty cycle at the highest operating speed.

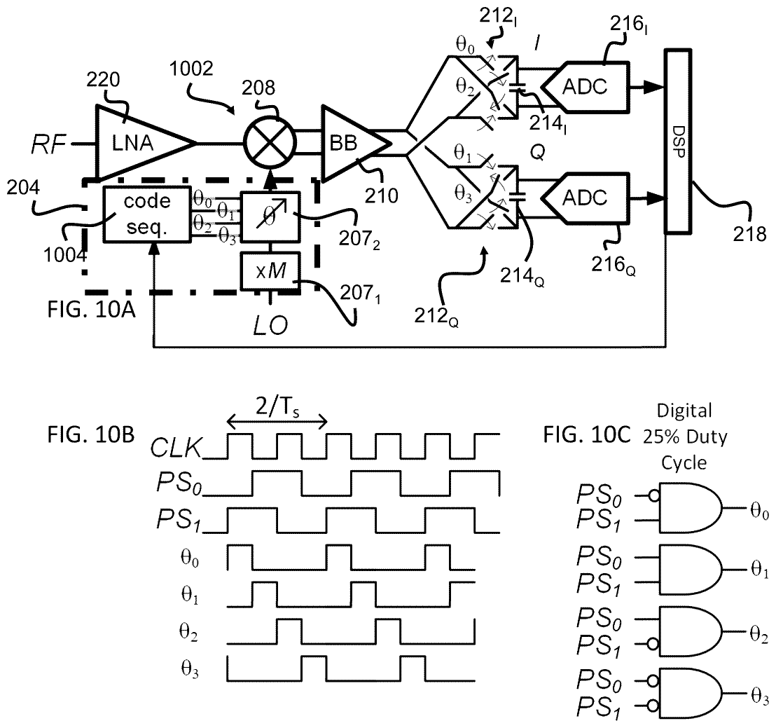

FIG. 10A is a block diagram of a phase-multiplexed quadrature receiver 1002 according to a preferred embodiment. Common components use the reference numerals introduced in FIG. 2A. The receiver 1002 includes a code sequence from a code sequence generator 1004 can be used to scramble the phases used to demodulate the RF waveform and thereby correlate the signal against a code. The code sequence is compared to the code sequence added to the transmit signal. In other words, an FMCW (frequency modulated continuous wave) signal is tagged with a code sequence and the receiver 1002 identifies the code sequence. The code sequence could be of arbitrary length and is repeated after the sequence is applied to the generator 1004. The generator 1004 loads a digital code sequence (of length M) from the DSP 218. Each sequence of the code is converted into a phase shift and switched through the phase shifter with a period of CLK/M. The code sequence is used to select the phase. The simplest case of a code is to use a clock signal 01010 as the code. In this case, divide the clock down 00110011 and then generate two bit sequences b0=0101 and b1=0011. When (b0,b1)=(0,0), the phase is 0. When the (b0,b1)=(0,1), the phase is 90. When (b0,b1)=(1,0) the phase is 180. When (b0,b1)=(1,1), the phase is 270. More generally a code might be any random sequence. So code is 00100111 might trigger the sequence (0,180,90,270). The code of 00111001 would trigger the sequence (0,270,180,90). Etc.

FIG. 10B is a timing diagram for the code sequence generator 1004. FIG. 10C is control logic for the code sequence generator 1004. FIG. 10A shows that the sequence of phases applied to the mixer 208 does not have to be a linear sequence (i.e. 0, 90, 180, 270, repeat) but might follow some coded sequence of phases that distinguish the signal. For example, in a radar, many FMCW signals might be transmitted from different locations. To identify a particular transmitters FMCW sequence a code sequence (CODE A) might be applied to the FMCW waveform. CODE A might be a randomized code sequence of length N, e.g., (0, 180, 0, 18). This would be identifiable against another code (CODE B) that might be the sequence (0, 0, 0, 0). To distinguish CODE A from CODE B, the phase shifter used with the mixer is modulated with the desired code sequence. This will correlate the RF signal against the code sequence while the undesired code sequence is averaged out.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A phase-multiplexed quadrature receiver comprising:
an RF signal interface providing an RF signal to an single mixer;
a local oscillator;
a generator to generate phase shift signals to multiplex phase states of the local oscillator applied to the-mixer between at least four I/Q phases within each symbol period of the RF signal to produce a complex radio-frequency waveform; and
a synchronized set of baseband switches that sample voltage from the mixer across at least two capacitors to demodulate the complex radio-frequency waveform into in-phase and quadrature components.

2. The phase-multiplexed quadrature receiver of claim 1, wherein the generator comprises a phase shifter.

3. The phase-multiplexed quadrature receiver of claim 1, wherein the generator comprises a phase shifter that comprises a code sequence generator.

4. The phase-multiplexed quadrature receiver of claim 1, wherein the mixer is the only mixer in the phase-multiplexed quadrature receiver.

5. The phase-multiplexed quadrature receiver of claim 1, consisting of a single path from the RF signal interface through the I/Q mixer.

6. The phase-multiplexed quadrature receiver of claim 1, consisting of a single baseband amplifier amplifying the complex radio-frequency waveform prior to the set of baseband switches.

7. The phase-multiplexed quadrature receiver of claim 1, wherein the set of baseband switches are switched at the same rate as the phase shift signals.

8. The phase-multiplexed quadrature receiver of claim 1, wherein the generator uses a CLK signal that is determined by an estimate of the symbol period of the RF signal.

9. The phase-multiplexed quadrature receiver of claim 8, wherein the estimate of the symbol period is provided by a digital signal processor that decodes the in-phase and quadrature components.

10. The phase-multiplexed quadrature receiver of claim 1, wherein the phase shift signals create a sequential sequence of phases.

11. The phase-multiplexed quadrature receiver of claim 1, wherein the phase shift signals create a coded sequence of phases.

12. The phase-multiplexed quadrature receiver of claim 1, wherein the phase shift signals create a randomized sequence of phases.
